(19) United States
(12) Patent Application Publication
(10) Pub. No.: US 2024/0115894 A1
(43) Pub. Date: Apr. 11, 2024

(54) TENSION INDICATING DEVICE AND FIRE SUPPRESSION SYSTEM COMPRISING TENSION INDICATING DEVICE

(71) Applicant: Carrier Corporation, Palm Beach Gardens, FL (US)

(72) Inventor: Thomas Kjellman, Uxbridge, MA (US)

(21) Appl. No.: 18/479,779

(22) Filed: Oct. 2, 2023

Related U.S. Application Data
(60) Provisional application No. 63/378,453, filed on Oct. 5, 2022.

(51) Int. Cl. A62C 37/42; A62C 3/00; A62C 37/48; A62C 37/50

(52) U.S. Cl. CPC A62C 37/42; A62C 3/006; A62C 37/48; A62C 37/50

(57) ABSTRACT

A tension indicating for a fire suppression system device is disclosed, including a body including first and second ends. At least one of the first and second ends is configured to be operatively coupled to a tensioned line of a mechanical fire detection line of a fire suppression system. The tension indicating device further includes a piston configured to be slidably disposed along a length of the body, the piston configured to be operatively coupled to the tensioned line of the mechanical fire detection line. The piston is provided with a movable indicator. Responsive to the tensioned line being provided with tension, the piston moves towards the end of the body, thereby causing the movable indicator to correspondingly move to indicate a tension in the tensioned line of the fire suppression system.

### CROSS-REFERENCE TO RELATED APPLICATION

This patent application claims the benefit of priority of U.S. Provisional Patent Application No. 63/378,453, filed on Oct. 5, 2022.

### TECHNICAL FIELD

This invention relates to the field of fire suppression systems, and more particularly, to a tension indicating device for a mechanical fire detection line of a fire suppression system.

### BACKGROUND

Fire suppression systems for industrial and commercial applications may include mechanical fire detection lines, which may include sensors to detect fires. The mechanical fire detection lines further include one or more tensioned lines that couple the sensors together. Once a fire is detected by any sensor, the sensor breaks, and the tensioned lines that were previously held under tension are now lax. This loss in tension may be used as a control signal to activate a control panel to deploy countermeasures to limit the fire. There is, therefore, a need for a means to monitor the tension in the tensioned lines of the mechanical fire detection line.

### SUMMARY

Disclosed herein is a tension indicating device for a fire suppression system. The tension indicating device includes a body including first and second ends. At least one of the first and second ends is configured to be operatively coupled to a tensioned line of a mechanical fire detection line of a fire suppression system. The tension indicating device further includes a piston configured to be slidably disposed along a length of the body. The piston includes a piston head and a connecting rod. A free end of the connecting rod extends towards the at least one of the first and second ends. Further, the free end is configured to be coupled to the tensioned line of the mechanical fire detection line. The piston head is provided with a movable indicator. Responsive to the tensioned line being provided with tension, the piston moves towards the at least one of the first and second ends of the body, thereby causing the movable indicator to correspondingly move along the length of the body of the tension indicating device to indicate a tension in the tensioned line of the fire suppression system.

In one or more embodiments, the tension indicating device further includes a reference indicator provided on the body of the tension indicating device. The reference indicator is located, such that when the movable indicator is in alignment with the reference indicator, the tension indicating device indicates that the tensioned line is correctly tensioned.

In one or more embodiments, when the movable indicator is not in alignment with the reference indicator, the tension indicating device indicates that the tensioned line is improperly tensioned.

In one or more embodiments, the tension indicating device indicates that the tensioned line is having one of excessive tension and inadequate tension based on location of the movable indicator with respect to the reference indicator.

In one or more embodiments, the tension indicating device further includes a compressible element configured to be disposed between the piston head and the first end of the body. Responsive to the tensioned line being provided with tension, the piston moves towards the second end of the body, thereby causing the compressible element to extend.

In one or more embodiments, the tension indicating device further includes a compressible element configured to be disposed between the piston head and the second end of the body. Responsive to the tensioned line being provided with tension, the piston moves towards the second end of the body, thereby causing the compressible element to compress.

In one or more embodiments, the compressible element in a helical spring.

In one or more embodiments, the tension indicating device further includes a window provided on the body to allow visual inspection of location of the movable indicator.

Also disclosed herein is a fire suppression system including a tension indicating device for a mechanical fire detection line. The tension indicating device includes a body including first and second ends. At least one of the first and second ends is configured to be operatively coupled to a tensioned line of a mechanical fire detection line of a fire suppression system. The tension indicating device further includes a piston configured to be slidably disposed along a length of the body. The piston includes a piston head and a connecting rod. A free end of the connecting rod extends towards the at least one of the first and second ends. Further, the free end is configured to be coupled to the tensioned line of the mechanical fire detection line. The piston head is provided with a movable indicator. Responsive to the tensioned line being provided with tension, the piston moves towards the at least one of the first and second ends of the body, thereby causing the movable indicator to correspondingly move along the length of the body of the tension indicating device to indicate a tension in the tensioned line of the fire suppression system. Furthermore, in a deployed state of the mechanical fire detection line, the movable indicator is located such that the tension indicating device indicates that the tensioned line is correctly tensioned.

In one or more embodiments, the tension indicating device further includes a reference indicator provided on the body of the tension indicating device. The reference indicator is located, such that when the movable indicator is in alignment with the reference indicator, the tension indicating device indicates that the tensioned line is correctly tensioned.

In one or more embodiments, when the movable indicator is not in alignment with the reference indicator, the tension indicating device indicates that the tensioned line is improperly tensioned.

In one or more embodiments, the tension indicating device indicates that the tensioned line is having one of excessive tension and inadequate tension based on location of the movable indicator with respect to the reference indicator.

In one or more embodiments, the tension indicating device further includes a compressible element configured to be disposed between the piston head and the first end of the body. Responsive to the tensioned line being provided with tension, the piston moves towards the second end of the body, thereby causing the compressible element to extend.

In one or more embodiments, the tension indicating device further includes a compressible element configured to be disposed between the piston head and the second end of the body. Responsive to the tensioned line being provided with tension, the piston moves towards the second end of the body, thereby causing the compressible element to compress.

In one or more embodiments, the compressible element in a helical spring.

In one or more embodiments, the tension indicating device further includes a window provided on the body to allow visual inspection of location of the movable indicator.

The foregoing summary is illustrative only and is not intended to be in any way limiting. In addition to the illustrative aspects, embodiments, and features described above, further aspects, embodiments, features, and techniques of the invention will become more apparent from the following description taken in conjunction with the drawings.

### BRIEF DESCRIPTION OF THE DRAWINGS

The accompanying drawings are included to provide a further understanding of the subject disclosure of this invention and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is an exemplary schematic view of a fire suppression system diagram illustrating an exemplary fire suppression system, in accordance with one or more embodiments of the invention;

FIG. 2 is a schematic view of the fire suppression system including a tension indicating device, in accordance with one or more embodiments of the invention;

FIG. 3A is a schematic sectional view the tension indicating device indicating improper tensioning, in accordance with one or more embodiments of the invention; and

FIG. 3B is a schematic sectional view the tension indicating device of FIG. 3A indicating improper tensioning, in accordance with one or more embodiments of the invention;

FIG. 4A is a schematic sectional view the tension indicating device indicating improper tensioning, in accordance with one or more embodiments of the invention; and

FIG. 4B is a schematic sectional view the tension indicating device of FIG. 4A indicating improper tensioning, in accordance with one or more embodiments of the invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components of this invention. described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components.

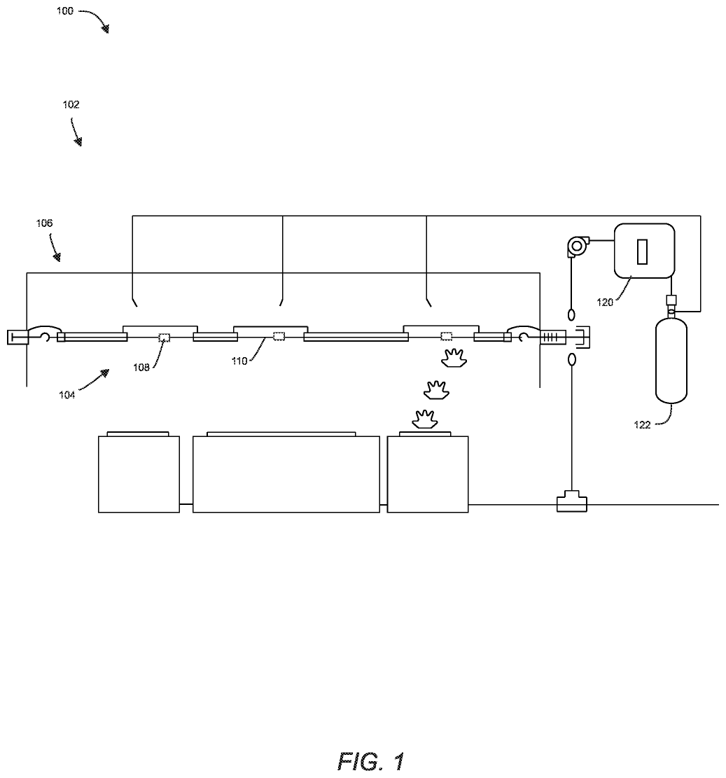

Referring to FIG. 1, an exemplary schematic view of a fire suppression system 100 is shown. The fire suppression system 100 may be used in industrial and commercial applications. In the illustrated view of FIG. 1, the fire suppression system 100 is one used in a commercial cooking application 102. The fire suppression system 100 includes a mechanical fire detection line 104 disposed within a hood 106 of the commercial cooking application 102. The mechanical fire detection line 104 may include one or more sensors 108 that are linked together via a tensioned line 110. When a fire may break out, the heat of the fire may cause one or more sensors 108 to break, thereby causing a drop in a tension of the tensioned line 110. This decrease in the tension of the tensioned line 110 may be used as a control signal to operate a control box 120. The control box 120 may then deploy countermeasures to suppress the fire that broke out. The countermeasures may include dispensing a fire suppression agent that is stored in a cannister 122.

In order for the fire suppression system 100 to adequately function, it is important that the tension in the tensioned line 110 be of a correct value. Correct value of tension may be defined as a range of tension values that allow one or more sensors 108 to be held intact in the absence of fire and allow a suitable change in tension to be experienced on breakage of any one or more sensors 108 in order to provide a control signal. Specifically, the correct value of tension may be defined to include a range of values where the tension in the tensioned line 110 is high enough that, upon breakage of the one or more sensors 108, the tensioned line 110 separates to provide the control signal to the control box 120. Further, the correct value of tension may include a range of values where the tension in the tensioned line 110 is not so high that the tension in the tensioned line 110 causes the one or more sensors 108 to break in the absence of fire.

In some embodiments, the correct value of tension may be dependent on application attributes of the fire suppression system 100. Some examples of application attributes may include a maximum temperature allowable in an environment where the fire suppression system 100 may be deployed, a required sensitivity of the fire suppression system 100, etc. In some examples, the correct value of tension may also be set by a manufacturer or a user of the fire suppression system 100.

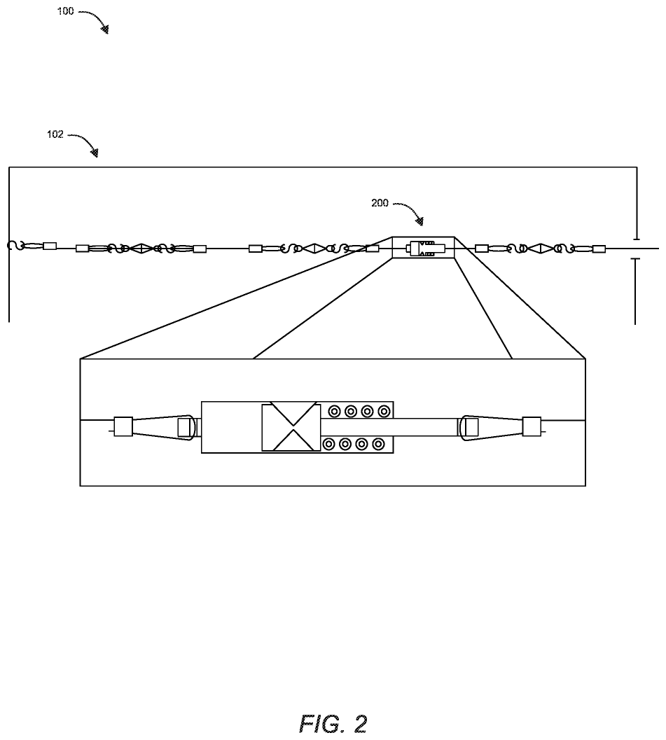

To indicate tension in the tensioned line 110, the mechanical fire detection line 104 may include a tension indicating device 200. Referring to FIG. 2, an exemplary schematic view of the fire suppression system 100 is shown, along with the tension indicating device 200. The tension indicating device 200 may be arranged in the mechanical fire detection line 104, in line with the one or more sensors 108.

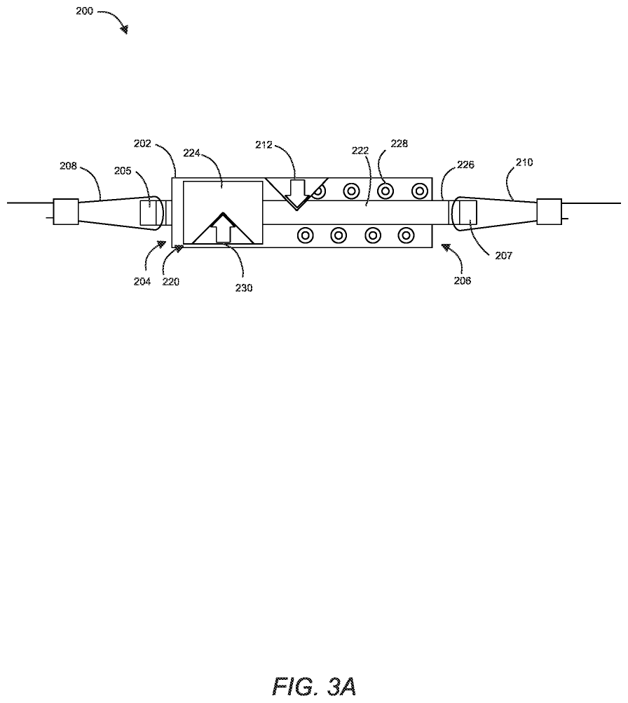

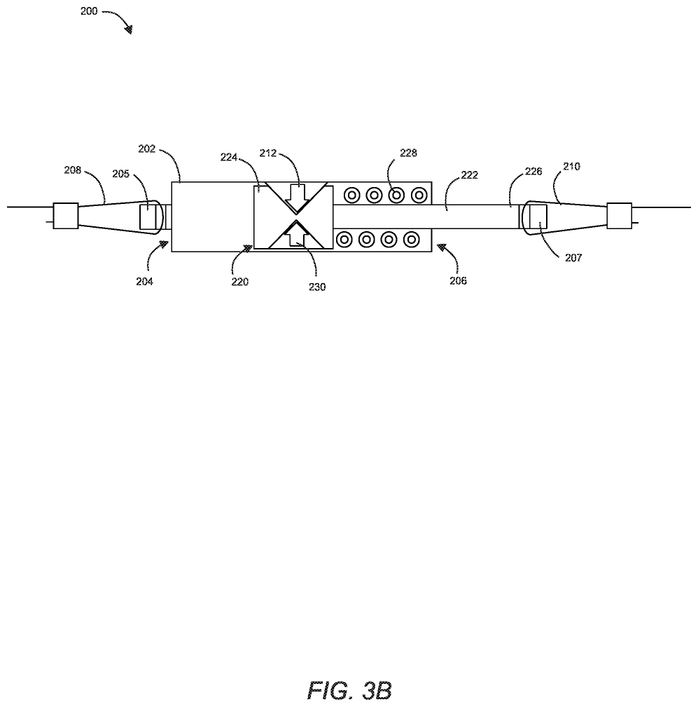

FIGS. 3A and 3B show exemplary schematic views of the tension indicating device 200 indicating improper tensioning, and correct tensioning, respectively. The tension indicating device 200 includes a body 202 including first and second ends 204, 206. The first and second ends 204, 206 may be configured to be operatively coupled to any one of the one or more sensors 108 (not shown in FIGS. 3A and 3B) via tensioned lines 208, 210. In some embodiments, the first and second ends 204, 206 may be configured to be directly, or indirectly coupled to the tensioned lines 208, 210. In the illustrated embodiment of FIGS. 3A and 3B, the first and second ends 204, 206 are provided with first and second protrusions 205, 207, respectively. The first and second protrusions 205, 207 may be configured to couple the first and second ends 204, 206, respectively with the tensioned lines 208, 210. However, in some embodiments, the tensioned lines 208, 210 may be directly coupled to the first and second ends 204, 206. In some embodiments, any one of the first and second ends 204, 206 may be linked to a rigid structure, such as a wall of the commercial cooking application 102 (shown in FIGS. 1 and 2). The tension indicating device 200 further includes a reference indicator 212. The reference indicator 212 may be a mark or a notch that may be visually accessible for inspection. The reference indicator 212 may be provided on a window on the body 202 of the tension indicating device 200.

The tension indicating device 200 further includes a piston 220 comprising a connecting rod 222 coupled to a piston head 224. The piston 220 is disposed within the body 202 of the tension indicating device 200 and is adapted to slide along a length of the tension indicating device 200. The connecting rod 222 includes a free end 226 that extends outside of the body 202 of the tension indicating device 200. The free end 226 of the connecting rod 222 is adapted to be coupled to one of the tensioned lined 208, 210. In the illustrated embodiment of FIG. 3A, the free end 226 of the connected rod 222 is coupled to the tensioned line 210. The tension indicating device 200 further includes a compressible element 228 disposed within the body 202 of the tension indicating device 200 and arranged between the piston head 224 and any one of the first and second ends 204, 206 of the body 202 of the tension indicating device 200. In the illustrated embodiment of FIG. 3A, the compressible element 228 is arranged between the piston head 224 and the second end 206 of the body 202 of the tension indicating device 200. The compressible element 228 is arranged such that, as the piston head 224 moves towards the second end 206 of the body 202 of the tension indicating device 200, the compressible element 228 is compressed and thereby, offers a resistance to motion of the piston head 224. The resistance offered by the compressible element 228 as it is compressed provides a tension to the connected tensioned line 210 in a direction opposite to a direction of compression of the compressible element 228. In some embodiments, the tension in the tensioned line 210 may be increased with increased compression of the compressible element 228. In some embodiments, the tension in the tensioned line 210 may be increased with increased stiffness of the compressible element 228. In some embodiments, the compressible element 228 includes a helical spring.

The tension indicating device 200 further includes a movable indicator 230 provided on the piston head 224 of the piston 220. As the piston head 224 slides along the length of the body 202 of the tension indicating device 200, the movable indicator 230 correspondingly moves along the length of the body 202 of the tension indicating device 200. When the movable indicator 230 aligns with the reference indicator 212, the tension indicating device 200 may indicate that the tension in the tensioned lines 208, 210 is correct. The position of the reference indicator 212 may be configured according to application requirements. For example, the reference indicator 212 may be in different positions depending on the dimensions of the body 202 of the tension indicating device 200, the nature and stiffness of the compressible element 228, and the tension that may be considered correct for a mechanical fire detection line.

Referring to FIGS. 2 and 3A, the tension indicating device 200 is shown to indicate an improper tensioning of the tensioned lines 208, 210. In such a state, the reference indicator 212 and the movable indicator 230 are not aligned, indicating that that the tension in the tensioned lines 208, 210 are outside of optimal values. In the illustrated embodiment of FIG. 3A, the position of the movable indicator 230 may indicate that the tension in the tensioned lines 208, 210 are below the optimum value.

Referring now to FIGS. 2 and 3B, the tension indicating device 200 is shown to indicate a correct tensioning of the tensioned lines 208, 210. As the tensioned line 210 is tensioned, i.e., as a pulling force is applied to the tensioned line 210, the tensioned line 210, in turn, forces the piston 220 to move towards the second end 206 of the body 202 of the tension indicating device 200. The pulling force may be applied to the tensioned line 210 until the piston 220 is moved to a point, such that the movable indicator 230 on the piston head 224 aligns with the reference indicator 212 on the body 202 of the tension indicating device 200. Such a condition indicates that the tensioned lines 208, 210 are correctly tensioned to operate in the fire suppression system 100.

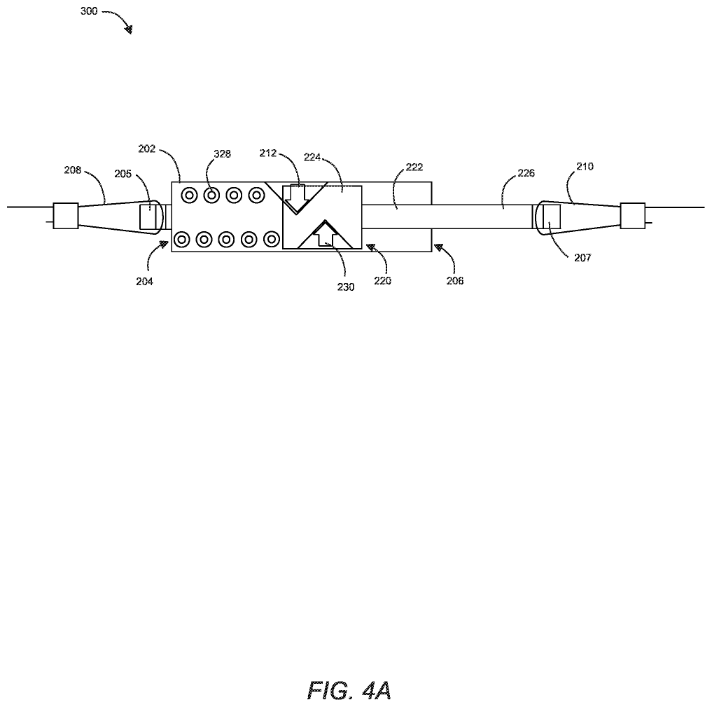

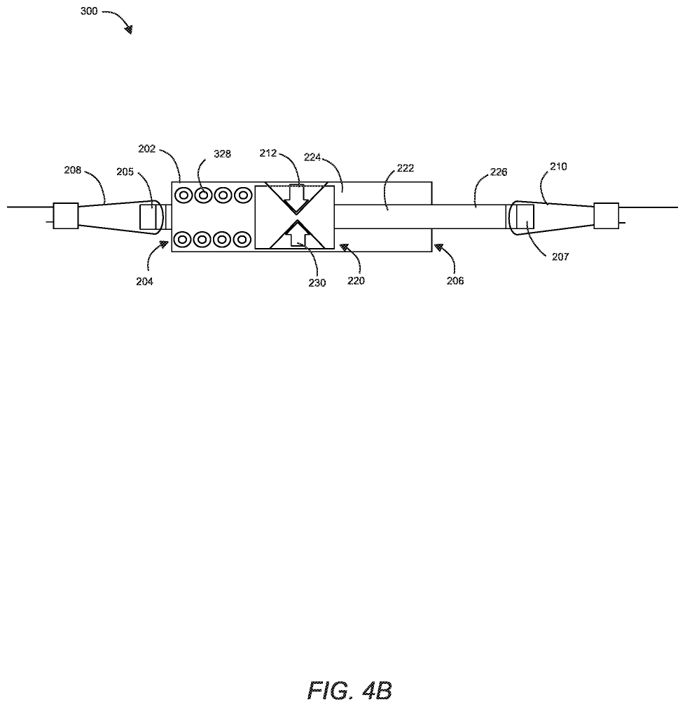

FIGS. 4A and 4B show exemplary schematic views of a tension indicating device 300 indicating improper tensioning, and correct tensioning, respectively. The tension indicating device 300 of FIGS. 4A and 4B may be substantially similar to the tension indicating device 200 of FIGS. 3A and 3B. Hence, common components between the tension indicating device 200 and the tension indicating device 300 are referenced by the same numeral references. However, the tension indicating device 300 includes a compressible element 328 disposed within the body 202 of the tension indicating device 300 and arranged between the piston head 224 and the first end 204 of the body 202 of the tension indicating device 300.

The compressible element 328 is arranged such that, as the piston head 224 moves towards the second end 206 of the body 202 of the tension indicating device 300, the compressible element 328 is extended, and thereby offers a resistance to motion of the piston head 224. The resistance offered by the compressible element 328 as it is extended state provides a tension to the connected tensioned line 210 in a direction same as a direction of extension of the compressible element 328. In some embodiments, the tension in the tensioned line 210 may be increased with increased extension of the compressible element 328. In some embodiments, the tension in the tensioned line 210 may be increased with increased stiffness of the compressible element 328. In some embodiments, the compressible element 328 includes a helical spring.

Referring to FIGS. 2, 3A and 4A, the tension indicating device 300 is shown to indicate an improper tensioning of the tensioned lines 208, 210. In such a state, the reference indicator 212 and the movable indicator 230 are not aligned, indicating that that the tension in the tensioned lines 208, 210 are outside of the optimal values. In the illustrated embodiment of FIG. 4A, the position of the movable indicator 230 may indicate that the tension in the tensioned lines 208, 210 is greater than the optimum value.

Referring now to FIGS. 2, 3B and 4B, the tension indicating device 300 is shown to indicate a correct tensioning of the tensioned lines 208, 210. Such a condition indicates that the tensioned lines 208, 210 are correctly tensioned to operate in the fire suppression system 100.

Thus, the tension indicating device 200, 300 may be used to accurately tension the tensioned lines 208, 210 of the mechanical fire detection line in order to allow the fire suppression system to optimally function. Further, the tension in the tensioned lines 208, 210 may be periodically monitored using the window to view the relative locations of the reference indicator 212 and the movable indicator 230.

While the invention has been described with reference to exemplary embodiments, it will be understood by those skilled in the art that various changes may be made and equivalents may be substituted for elements thereof without departing from the scope of the invention as defined by the appended claims. Modifications may be made to adopt a particular situation or material to the teachings of the invention without departing from the scope thereof. Therefore, it is intended that the invention not be limited to the particular embodiment disclosed, but that the invention includes all embodiments falling within the scope of the invention as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A tension indicating device for a fire suppression system, the device comprising:
a body comprising first and second ends, at least one of the first and second ends configured to be operatively coupled to a tensioned line of a mechanical fire detection line of a fire suppression system; and
a piston configured to be slidably disposed along a length of the body, the piston comprising a piston head and a connecting rod, wherein a free end of the connecting rod extends towards the at least one of the first and second ends, wherein the free end is configured to be coupled to the tensioned line of the mechanical fire detection line, and wherein the piston head is provided with a movable indicator,
wherein responsive to the tensioned line being provided with tension, the piston moves towards the at least one of the first and second ends of the body, thereby causing the movable indicator to correspondingly move along the length of the body of the tension indicating device to indicate a tension in the tensioned line of the fire suppression system.

2. The tension indicating device of claim 1, further comprising a reference indicator provided on the body of the tension indicating device, wherein the reference indicator is located, such that when the movable indicator is in alignment with the reference indicator, the tension indicating device indicates that the tensioned line is correctly tensioned.

3. The tension indicating device of claim 2, wherein when the movable indicator is not in alignment with the reference indicator, the tension indicating device indicates that the tensioned line is improperly tensioned.

4. The tension indicating device of claim 2, wherein the tension indicating device indicates that the tensioned line is having one of excessive tension and inadequate tension based on location of the movable indicator with respect to the reference indicator.

5. The tension indicating device of claim 1, further comprising a compressible element configured to be disposed between the piston head and the first end of the body, wherein, responsive to the tensioned line being provided with tension, the piston moves towards the second end of the body, thereby causing the compressible element to extend.

6. The tension indicating device of claim 1, further comprising a compressible element configured to be disposed between the piston head and the second end of the body, wherein, responsive to the tensioned line being provided with tension, the piston moves towards the second end of the body, thereby causing the compressible element to compress.

7. The tension indicating device of claim 6, wherein the compressible element in a helical spring.

8. The tension indicating device of claim 7, further comprising a window provided on the body to allow visual inspection of location of the movable indicator.

9. A fire suppression system comprising a tension indicating device for a mechanical fire detection line, the tension indicating device comprising:
a body comprising first and second ends, at least one of the first and second ends configured to be operatively coupled to a tensioned line of a mechanical fire detection line of a fire suppression system; and
a piston configured to be slidably disposed along a length of the body, the piston comprising a piston head and a connecting rod, wherein a free end of the connecting rod extends towards the at least one of the first and second ends, wherein the free end is configured to be coupled to the tensioned line of the mechanical fire detection line, and wherein the piston head is provided with a movable indicator,
wherein responsive to the tensioned line being provided with tension, the piston moves towards the at least one of the first and second ends of the body, thereby causing the movable indicator to correspondingly move along the length of the body of the tension indicating device to indicate a tension in the tensioned line of the fire suppression system, and
wherein, in a deployed state of the mechanical fire detection line, the movable indicator is located, such that the tension indicating device indicates that the tensioned line is correctly tensioned.

10. The fire suppression system of claim 9, wherein the tension indicating device further comprises a reference indicator provided on the body of the tension indicating device, wherein the reference indicator is located, such that when the movable indicator is in alignment with the reference indicator, the tension indicating device indicates that the tensioned line is correctly tensioned.

11. The fire suppression system of claim 10, wherein when the movable indicator is not in alignment with the reference indicator, the tension indicating device indicates that the tensioned line is improperly tensioned.

12. The fire suppression system of claim 10, wherein the tension indicating device indicates that the tensioned line is having one of excessive tension and inadequate tension based on location of the movable indicator with respect to the reference indicator.

13. The fire suppression system of claim 10, further compressing a compressible element configured to be disposed between the piston head and the first end of the body, wherein, responsive to the tensioned line being provided with tension, the piston moves towards the second end of the body, thereby causing the compressible element to extend.

14. The fire suppression system of claim 10, further comprising a compressible element configured to be disposed between the piston head and the second end of the body, wherein, responsive to the tensioned line being provided with tension, the piston moves towards the second end of the body, thereby causing the compressible element to compress.

15. The fire suppression system of claim 14, wherein the compressible element in a helical spring.

16. The fire suppression system of claim 15, wherein the tension indicating device further comprises a window provided on the body to allow visual inspection of location of the movable indicator.
